(19) United States
(12) Patent Application Publication
(10) Pub. No.: US 2005/0247034 A1
(43) Pub. Date: Nov. 10, 2005

(54) Air filter assembly module

(75) Inventors: Carlos Augusto Canova, Sao Paulo (BR); Fabio Moreira, Sao Paulo (BR)

Correspondence Address: GREER, BURNS & CRAIN, 300 S WACKER DR, 25TH FLOOR, CHICAGO, IL, 60606, US

(73) Assignee: Sogefi Filtration Do Brasil Ltda.

(21) Appl. No.: 10/957,496

(22) Filed: Oct. 1, 2004

(30) Foreign Application Priority Data
May 7, 2004 (BR) PI0401709-9

(51) Int. Cl. B01D 50/00; F26B 3/00

(52) U.S. Cl. 55/385.3; 123/198 E

(57) ABSTRACT

An air filter assembly module, belonging to the field of auto parts, and that was developed to improve air supply to internal combustion engines and their performance, includes: a dirty air admission inlet; a chamber, in which the inlet opens; an air filtering element housed in the chamber; a clean air outlet, derived from the chamber and positioned downstream the filtering element; means of noise reduction; an apparatus for recirculation of oil vapors from the oil sump to the combustion chamber; an airflow converger located at the outlet of the module having selected geometry in order for the airflow, subject to constant or variable flow conditions, to be converted from turbulent flow with high recirculation rate to laminar flow with minimized or annulled recirculation rate and turbulence intensity, all incorporated and assembled in a housing assembly located at the top of the engine compartment.

This descriptive report refers to an invention patent for an air filter assembly module, belonging to the field of auto parts, and that was developed to improve air supply to internal combustion engines and their performance.

An air filter assembly module is already known, intended for supplying air to internal combustion engines of motor vehicles and essentially comprising: a dirty air inlet; a chamber, in which the inlet opens; by an air filtering element housed in the chamber; by a clean air outlet positioned downstream the filtering element and equipped with means for connection to the inlet of a carburetor or throttle body; by means of noise dampers and eventually others, all these incorporated in a housing and cover assembly located at the top of the engine compartment and mounted on rubber pads. This module is intended mainly for the collection, filtering and supply of air.

It happens that the flow of air supplied by said module usually has a turbulent condition with high recirculation rates (Kinetic turbulence energy, turbulence intensity, vortex number).

Findings from studies conducted show that such air supply conditions, especially in Otto cycle engines, determine reduction in power and torque.

Thus, the objective of the invention object of this patent is to provide an air filter assembly module that solves the above problem.

Another objective is to provide a module that solves the problem without requiring a complex structure and manufacturing to the point of making it uninteresting.

Another objective is to provide a module of adequate cost.

Considering, therefore, the abovementioned problems, and with the aim of solving them and meeting the objectives listed, the air filter assembly module object of this invention patent was developed, which, apart from the components that usually comprise it, as mentioned above, incorporates, at the outlet, an airflow converger, essentially comprising a tubular body with a broadened inlet at one end and fins for directing the flow and that receive the clean air that leaves the filtering element; internally, said body has an internal surface selected to convert the airflow, whether in constant or variable flow conditions, into laminar flow with minimized or annulled recirculation rate and turbulence intensity; and the opposite end of said body comprises an air outlet connected to the inlet of a carburetor or throttle body.

This type of module build, therefore, apart from its usual functions, incorporates a new function: that is of organizing the airflow supplied to the carburetor or throttle body. This promotes gain in power and torque when the module is applied in internal combustion engines, preferentially those operating in Otto cycles.

Despite the new function incorporated to the module, its structure and manufacture do not have levels of complexity that might render it uninteresting compared to the conventional.

Another advantage consists in the fact that the module's cost is not overly burdened with the inclusion of the air converger.

Another advantage consists in the fact that this module can be used in vehicles already existing or that come to be developed.

Furthermore, despite the improvement in this module, its installation and maintenance is essentially the same as for the conventional.

The attached drawings refer to the air filter assembly module of this patent, in which:

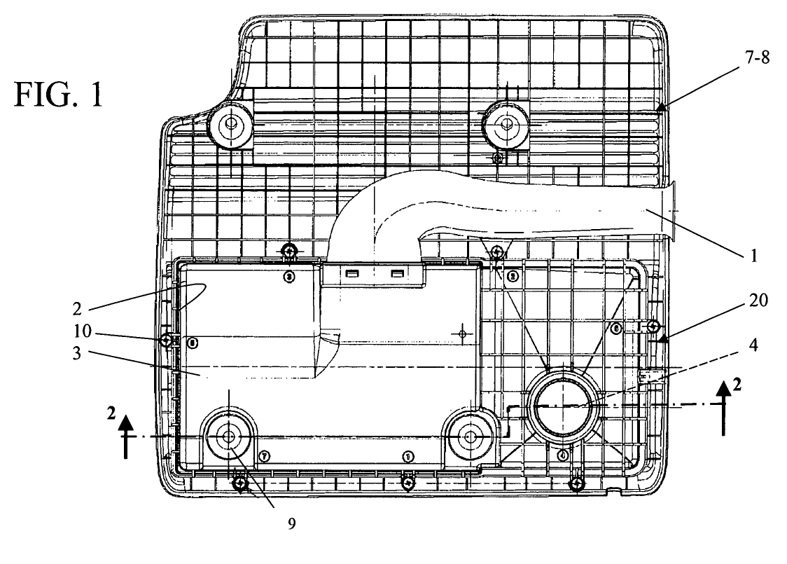

FIG. 1 shows a plan view; and

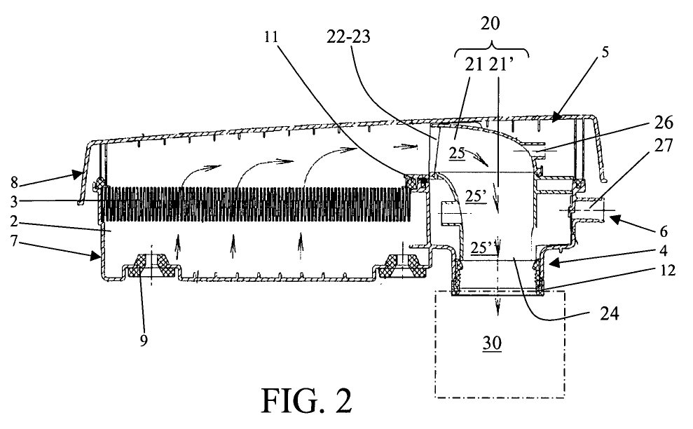

FIG. 2 shows a side view in section.

As shown by the abovementioned figures, the module object of this invention patent is intended to contain an air filter assembly for internal combustion engine and essentially comprises: a dirty air admission inlet 1; a chamber 2, in which the inlet opens; an air filtering element 3 housed in the chamber; a clean air outlet 4, derived from the chamber and positioned downstream the filtering element; means of noise reduction 5; means 6 of recirculation of oil vapors from the oil sump to the combustion chamber, all incorporated and assembled in a housing assembly 7-8 located at the top of the engine compartment, essentially comprising: a lower housing 7 equipped with rubber pads 9 for mounting in the place of use; a cover 8 that closes the housing 7; bolts 10 for fastening the housing and cover; sealing 11 that closes the gap between the housing and the cover; and sealing 12 that closes the gap between the module outlet and the inlet of the carburetor or throttle body 30.

In this invention, the module is, in addition to its usual components and functions, equipped with an airflow converger 20 downstream the filter 3 and at the clean air outlet 4, with selected geometry in order for the airflow, subject to constant or variable flow conditions and turbulence with high recirculation rates (Kinetic turbulence energy, turbulence intensity, vortex number) to operate in laminar flow conditions with minimized or annulled recirculation rate and turbulence intensity.

Therefore, said airflow converger 20 comprises a tubular body defined by: a broadened upper section 21-21′ in an essentially prismatic form with convex walls, and with an inlet 22 positioned vertically having fins 23 and opening at the outlet of an air filter 3; said body 21 is also defined by a lower section 21′ in a substantially cone frustum format, funneled from the base of the upper section 21 and ending in a cylindrical section having an outlet 24 positioned horizontally and connected to the inlet of a carburetor or throttle body 30.

Internally, said body 21-21′ defines a surface that acts on the airflow, defined: by an upper region 25 in an essentially semi-parabolic format, with axis of revolution substantially coinciding with the vertical medial axis of the inlet 22; by an intermediary region 25′ essentially in the form of a cone frustum that extends and is funneled from the upper region; and by a cylindrical lower region 25″ extended from the intermediary region, said surface adapted to change the condition of airflow, subject to constant or variable conditions, from turbulent with high recirculation rate to laminar, and to minimize or annul the recirculation rate and turbulence intensity.

The air inlet 22 is basically rectangular with horizontal dimension substantially greater than the vertical, and having the fins 23 positioned vertically and adequately spaced from each other.

The airflow converger 20 also has two bypasses 26 that, combined with the air volume between the cover 8 and the housing 7, form two Helmotz chambers for noise reduction. The bypasses have specific dimensions (length and diameter) for noise reduction through the principle of Helmotz resonator impedance.

As is known, the frequencies are generated by explosion in the combustion chamber of internal combustion engines due the mixture of air and fuel combusted by a spark or mechanical compression. Noise reduction of these frequencies promotes an acoustic behavior of more silent operation.

The airflow converger 20 also has a guide 27 for oil vapors from the oil sump, which will be redirected for burning in the combustion chamber. This guide 27 is assembled in a way as to house the valve for oil vapor without communication with the Helmotz resonators.

This module and the airflow converger 20 are obtained from injected thermoplastic material.

Therefore, this air filter assembly module has the usual functions of: collecting dirty air from the environment, filtering it and supplying it cleaned in the inlet of the carburetor or throttle body 30, executed by usual means, and added by the function of, at the filter outlet, changing the turbulent airflow with constant or variable flow and high recirculation rate to laminar flow with minimized or annulled turbulence intensity, this function being performed by the airflow converter 20. This, together with the air volume between the housing 7 and cover 8 and through its bypasses also performs the function of noise damper. Said airflow converger 20, through its guide 27, also collaborates in the function of recirculation of oil vapors from the oil sump to the combustion chambers.

In the basic structure described above, the airflow converger object of this invention patent can present modifications related to materials, dimensions, constructive details and/or functional/decorative configuration, without deviating from the scope of the protection desired.

1) An air filter assembly module comprising: a dirty air admission inlet; a chamber, in which the inlet opens; an air filtering element housed in the chamber; a clean air outlet, derived from the chamber and positioned downstream of the filtering element; noise dampers; means of recirculation of oil vapors from the oil sump to the combustion chamber, all incorporated and assembled in a housing assembly located at the top of the engine compartment, wherein the fact of its having, downstream the filter and at the clean air outlet an airflow converger with selected geometry in order for the airflow, subject to constant or variable flow conditions, to be converted from turbulent flow with high recirculation rate to laminar flow with minimized or annulled recirculation rate and turbulence intensity; said airflow converger comprises a tubular body equipped, at the upper end, with an air inlet positioned vertically and opening at the air filter outlet and having parallel fins that direct the flow lines in parallel; internally, said body has a surface that acts on the airflow; and the opposite end of said body has an outlet positioned horizontally and connected to the inlet of a carburetor or throttle body of a vehicle's engine system.

2) The air filter assembly module according to claim 1, wherein the fact that the tubular body is defined by a broadened upper section, in an essentially prismatic form with convex walls, with the inlet positioned vertically, having fins and opening at the air filter outlet; said body is also defined by a lower section in a substantially cone frustum format, funneled from the base of the upper section and ending in a cylindrical section with an outlet positioned horizontally and connected to the inlet of a carburetor or throttle body.

3) The air filter assembly module according to claim 2, wherein by the fact that the inner surface comprises: an upper region in an essentially semi-parabolic format, with axis of revolution substantially coinciding with the vertical medial axis of the inlet; an intermediary region essentially in a cone frustum format, that extends and is funneled from the upper region; and a cylindrical lower region extending from the intermediary region and ending at the outlet.

4) The air filter assembly module according to clam 1, wherein the fact that the airflow converger also has two bypasses that, combined with the air volume between the cover and the housing, form two Helmotz chambers for noise reduction.

5) The air filter assembly module according to claim 1, wherein the fact that the airflow converger also has a guide for oil vapors from the oil sump, which will be redirected for burning in the combustion chamber. This guide is assembled in a way as to house the valve for oil vapor without communication with the Helmotz resonators.
